(19) United States
(12) Patent Application Publication
(10) Pub. No.: US 2026/0134127 A1
(43) Pub. Date: May 14, 2026

(54) Cross-domain trust-independent permissions transformation

(71) Applicant: Nasuni Corporation, Boston, MA (US)

(72) Inventors: Richard Finger, West Palm Beach, FL (US); Rohn Noirot, North Canton, OH (US)

(21) Appl. No.: 18/943,044

(22) Filed: Nov. 11, 2024

(51) Int. Cl. G06F 21/62

(52) U.S. Cl. CPC G06F 21/6218

(57) ABSTRACT

A method, apparatus and computer program product for automated cross-domain permissions transformation without a dedicated domain controller or even the requirement to establish and maintain a domain trust relationship between a source domain and a target domain. According to one embodiment, permissions metadata is collected from a source file and folder structure, and information regarding users, groups and security identifiers is collected for both a source and a target domain. These data sets organized according to a set of configured electronic documents and stored in a relational database. The information in the database is validated and exported into a format that allows permissions metadata for the source file and folder structure to be applied either to the original location, or to a replica location. In one embodiment, that replica location is a cloud-native global file system.

### BACKGROUND OF THE INVENTION

It is known to provide a cloud-native global file system that is used to provide primary file storage for enterprise data. In this approach, edge appliances (or “filers”) typically located on-premises securely transmit all files, file versions and metadata to a preferred private or public cloud object store, while locally caching only active files. The appliances are stateless, and multiple appliances can mount the same volume in the cloud. As files are written locally, an authoritative copy of every file and metadata (inodes) are stored in the cloud. The system provides a single, unified namespace for all primary file data that is not bound by local hardware or network performance constraints. The above-described approach to enterprise file services also has been extended to provide multiple-site/multiple-filer access to the same namespace, thereby enabling participating users with the ability to collaborate on documents across multiple filers/sites. Major cloud platforms, e.g., Amazon® AWS, Microsoft® Azure, Google® Cloud and others, are then utilized as a write-once, read many object store for the enterprise primary file data, which is typically stored in volumes. A hybrid cloud solution of this type is available commercially from Nasuni® Corporation of Boston, Massachusetts.

While the above-described solution provides significant advantages, migration to a hybrid cloud solution of this type typically requires thorough planning and preparation to ensure that data movement from a legacy infrastructure happens without impacting regular file access and other data access requirements. Of particular concern in the migration planning and process is the question of how sensitive user data such as roles and permission in a source domain are to be mapped to an equivalent set of users and resources in the target domain. Traditional permissions migration typically requires a domain controller, and a domain trust relationship between the source and target domains such that the source data (e.g., user and group accounts, roles and permissions) is securely transformed by the controller into target data for use in the new domain. In some use cases, however, the source and target domains cannot have one-way or two-way trust relationships, or either or both of the source and target domains systems are not present at the location wherein the permissions transform must be performed. In these situations, the permissions transformation then requires a highly manual process that is very time-consuming, unreliable and, in the end, unsatisfactory.

There remains a need to provide cross-domain permissions transformation independent of the presence of a domain controller or even a trust domain relationship between source and target domains.

### SUMMARY OF THE INVENTION

A method, apparatus and computer program product for automated cross-domain permissions transformation. The techniques herein do not require a dedicated domain controller or even the requirement to establish and maintain a domain trust relationship between a source domain and a target domain.

According to one embodiment, permissions metadata is collected from a source file and folder structure, and information regarding users, groups and security identifiers is collected for both a source and a target domain. These data sets organized according to a set of configured electronic documents and stored in a relational database. The information in the database is validated (preferably on an identity-by-identity basis) and exported into a format that allows permissions metadata for the source file and folder structure to be applied either to the original location, or to a replica location. In one embodiment, that replica location is a cloud-native global file system.

The approach herein operates in an automated or semi-automated manner, and it greatly accelerates transformation of permissions. There is no requirement to enforce trust across the domains, or to have administrator domain credentials in place on both sides. Using the approach herein, and irrespective of the size or number of accounts, an enterprise can confidently and expeditiously move its enterprise data to the hybrid cloud with all roles and permissions intact.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

For a more complete understanding of the disclosed subject matter and the advantages thereof, reference is now made to the following descriptions taken in conjunction with the accompanying drawings, in which:

FIG. 1 is a block diagram illustrating how a known versioned file system interfaces a local file system to an object-based data store;

FIG. 2 is a block diagram of a representative implementation of a portion of the interface shown in FIG. 1;

FIG. 3 is a more detailed implementation of the interface where there are a number of local file systems of different types;

FIG. 4 illustrates the interface implemented as an appliance within a local processing environment;

FIG. 5 depicts a set of electronic documents and databases that are used to facilitate the automated permissions migration workflow of this disclosure;

FIG. 6 depict a typical domain permissions migration workflow according to this disclosure;

FIG. 7 depicts a process flow of the permissions migration workflow provided by a permission tool or service according to a preferred embodiment; and

FIG. 8 depicts an IdentityMap validation process referenced in the process flow of FIG. 7.

### DETAILED DESCRIPTION OF THE INVENTION

By way of background, the techniques herein may be implemented with respect to a source domain associated with an enterprise, and with respect to a target domain associated with a hybrid cloud, such as a cloud-native global file system that provides storage for the enterprise's data. This implementation, and in particular the use of the hybrid cloud being associated with the target domain, is not intended to be limiting, as the approach herein to permissions transformation may be implemented in any scenario wherein permissions data is required to be migrated from a source domain to any network-accessible target domain. For illustrative and background purposes, the cloud-native global file system is first described.

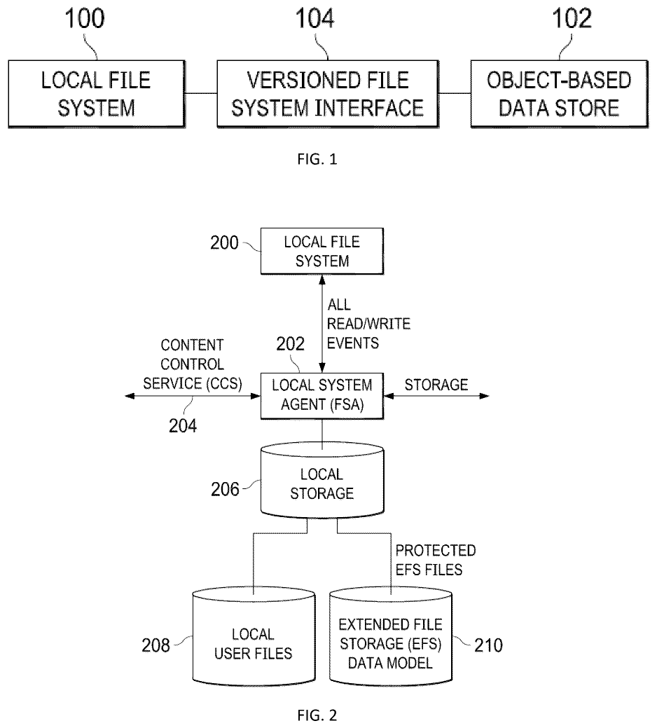

In particular, FIG. 1 illustrates a local file system 100 and an object-based data store 102. Although not meant to be limiting, preferably the object-based data store 102 is a “write-once” store and may comprise a “cloud” of one or more storage service providers. An interface 104 (or “filer”) provides for a “versioned file system” that only requires write-once behavior from the object-based data store 102 to preserve substantially its “complete” state at any point-in-time. As used herein, the phrase “point-in-time” should be broadly construed, and it typically refers to periodic “snapshots” of the local file system (e.g., once every “n” minutes). The value of “n” and the time unit may be varied as desired. The interface 104 provides for a file system that has complete data integrity to the cloud without requiring global locks. In particular, this solution circumvents the problem of a lack of reliable atomic object replacement in cloud-based object repositories. The interface 104 is not limited for use with a particular type of back-end data store. When the interface is positioned in “front” of a data store, the interface has the effect of turning whatever is behind it into a “versioned file system” (“VFS”). The VFS is a construct that is distinct from the interface itself, and the VFS continues to exist irrespective of the state or status of the interface (from which it may have been generated). Moreover, the VFS is self-describing, and it can be accessed and managed separately from the back-end data store, or as a component of that data store. Thus, the VFS (comprising a set of structured data representations) is location-independent. In one embodiment, the VFS resides within a single storage service provider (SSP) although, as noted above, this is not a limitation. In another embodiment, a first portion of the VFS resides in a first SSP, while a second portion resides in a second SSP. Generalizing, any given VFS portion may reside in any given data store (regardless of type), and multiple VFS portions may reside across multiple data store(s). The VFS may reside in an “internal” storage cloud (i.e., a storage system internal to an enterprise), an external storage cloud, or some combination thereof.

The interface 104 may be implemented as a machine. A representative implementation is the Nasuni® Filer, available from Nasuni® Corporation of Boston, Massachusetts. Thus, for example, typically the interface 104 is a rack-mounted server appliance comprising hardware and software. The hardware typically includes one or more processors that execute software in the form of program instructions that are otherwise stored in computer memory to comprise a “special purpose” machine for carrying out the functionality described herein. Alternatively, the interface is implemented as a virtual machine or appliance (e.g., via VMware®, or the like), as software executing in a server, or as software executing on the native hardware resources of the local file system. The interface 104 serves to transform the data representing the local file system (a physical construct) into another form, namely, a versioned file system comprising a series of structured data representations that are useful to reconstruct the local file system to any point-in-time. A representative VFS is the Nasuni Unity File System (UniFS®). Although not meant to be limiting, preferably each structured data representation is an XML document (or document fragment). As is well-known, extensible markup language (XML) facilitates the exchange of information in a tree structure. An XML document typically contains a single root element (or a root element that points to one or more other root elements). Each element has a name, a set of attributes, and a value consisting of character data, and a set of child elements. The interpretation of the information conveyed in an element is derived by evaluating its name, attributes, value and position in the document.

The interface 104 generates and exports to the write-once data store a series of structured data representations (e.g., XML documents) that together comprise the versioned file system. The data representations are stored in the data store. Preferably, the XML representations are encrypted before export to the data store. The transport may be performed using known techniques. In particular, REST (Representational State Transfer) is a lightweight XML-based protocol commonly used for exchanging structured data and type information on the Web. Another such protocol is Simple Object Access Protocol (SOAP). Using REST, SOAP, or some combination thereof, XML-based messages are exchanged over a computer network, normally using HTTP (Hypertext Transfer Protocol) or the like. Transport layer security mechanisms, such as HTTP over TLS (Transport Layer Security), may be used to secure messages between two adjacent nodes. An XML document and/or a given element or object therein is addressable via a Uniform Resource Identifier (URI). Familiarity with these technologies and standards is presumed.

FIG. 2 is a block diagram of a representative implementation of how the interface captures all (or given) read/write events from a local file system 200. In this example implementation, the interface comprises a file system agent 202 that is positioned within a data path between a local file system 200 and its local storage 206. The file system agent 202 has the capability of “seeing” all (or some configurable set of) read/write events output from the local file system. The interface also comprises a content control service (CCS) 204 as will be described in more detail below. The content control service is used to control the behavior of the file system agent. The object-based data store is represented by the arrows directed to “storage” which, as noted above, typically comprises any back-end data store including, without limitation, one or more storage service providers. The local file system stores local user files (the data) in their native form in cache 208. Reference 210 represents that portion of the cache that stores pieces of metadata (the structured data representations, as will be described) that are exported to the back-end data store (e.g., the cloud).

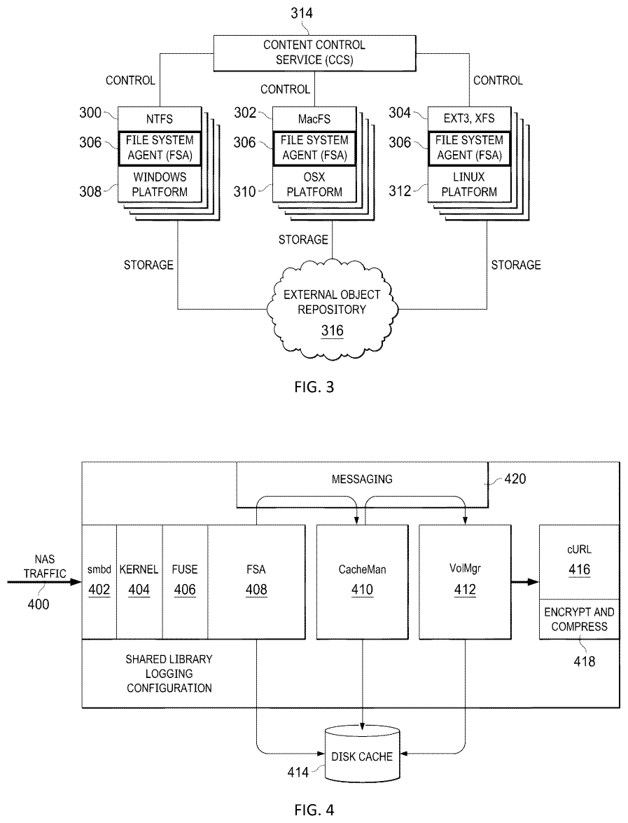

FIG. 3 is a block diagram illustrating how the interface may be used with different types of local file system architectures. In particular, FIG. 3 shows the CCS (in this drawing a Web-based portal) controlling three (3) FSA instances. Once again, these examples are representative, and they should not be taken to limit the invention. In this example, the file system agent 306 is used with three (3) different local file systems: NTFS 300 executing on a Windows operating system platform 308, MacFS (also referred to as “HFS+” (HFSPlus)) 302 executing on an OS X operating system platform 310, and EXT3 or XFS 304 executing on a Linux operating system platform 312. These local file systems may be exported (e.g., via CIFS, AFP, NFS or the like) to create a NAS system based on VFS. Conventional hardware, or a virtual machine approach, may be used in these implementations, although this is not a limitation. As indicated in FIG. 3, each platform may be controlled from a single CCS instance 314, and one or more external storage service providers may be used as an external object repository 316. As noted above, there is no requirement that multiple SSPs be used, or that the data store be provided using an SSP.

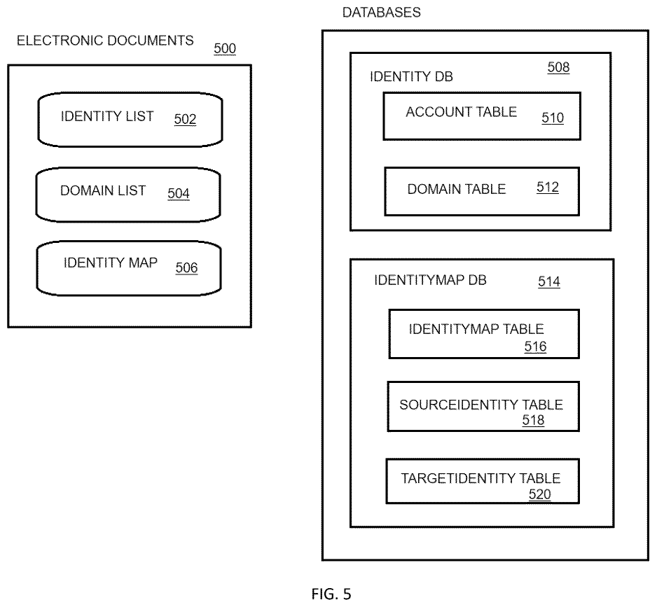

FIG. 4 illustrates the interface implemented as an appliance within a local processing environment. In this embodiment, the local file system traffic 400 is received over Ethernet and represented by the arrow identified as “NAS traffic.” That traffic is provided to smbd layer 402, which is a SAMBA file server daemon that provides CIFS (Windows-based) file sharing services to clients. The layer 402 is managed by the operating system kernel 404 is the usual manner. In this embodiment, the local file system is represented (in this example) by the FUSE kernel module 406 (which is part of the Linux kernel distribution). Components 400, 402 and 404 are not required to be part of the appliance. The file transfer agent 408 of the interface is associated with the FUSE module 406 as shown to intercept the read/write events as described above. The CCS (as described above) is implemented by a pair of modules (which may be a single module), namely, a cache manager 410, and a volume manager 412. Although not shown in detail, preferably there is one file transfer agent instance 408 for each volume of the local file system. The cache manager 410 is responsible for management of “chunks” with respect to a local disk cache 414. This enables the interface described herein to maintain a local cache of the data structures (the structured data representations) that comprise the versioned file system. The volume manager 412 maps the root of the FSA data to the cloud (as will be described below), and it further understands the one or more policies of the cloud storage service providers. The volume manager also provides the application programming interface (API) to these one or more providers and communicates the structured data representations (that comprise the versioned file system) through a transport mechanism 416 such as cURL. cURL is a library and command file tool for transferring files with URL syntax that supports various protocols such as FTP, FTPS, HTTP, HTTPS, SCP, SFTP, TFTP, TELNET, DICT, LDAP, LDAPS and FILE. cURL also supports SSL certificates, HTTP POST, HTTP PUT, FTP uploading, HTTP form based upload, proxies, cookies, user+password authentication, file transfer resume, proxy tunneling, and the like. The structured data representations preferably are encrypted and compressed prior to transport by the transformation module 418. The module 418 may provide one or more other data transformation services, such as duplicate elimination. The encryption, compression, duplicate elimination and the like, or any one of such functions, are optional. A messaging layer 420 (e.g., local socket-based IPC) may be used to pass messages between the file system agent instances, the cache manager and the volume manager. Any other type of message transport may be used as well.

The interface shown in FIG. 4 may be implemented as a standalone system, or as a managed service. In the latter case, the system executes in an end user (local file system) environment. A managed service provider provides the system (and the versioned file system service), preferably on a fee or subscription basis, and the data store (the cloud) typically is provided by one or more third party service providers. The versioned file system may have its own associated object-based data store, but this is not a requirement, as its main operation is to generate and manage the structured data representations that comprise the versioned file system. The cloud preferably is used just to store the structured data representations, preferably in a write-once manner, although the “versioned file system” as described herein may be used with any back-end data store.

The file system agent 408 is capable of completely recovering from the cloud (or other store) the state of the native file system and providing immediate file system access (once FSA metadata is recovered). The FSA can also recover to any point-in-time for the whole file system, a directory and all its contents, a single file, or a piece of a file.

The above-described platform and system delivers scale, data security and fast edge performance for enterprise users (customers). In a typical use case, an enterprise customer has its enterprise data on legacy network attached storage (NAS) and file server systems that will be migrated to the platform. In this migration scenario, the enterprise data, and in particular sensitive user data such as permissions, comprise a dataset that must be migrated from a source domain, and to a target domain associated with the cloud platform. For large enterprises, the amount of data involved is quite large and, as noted above, typically any such migration requires a domain controller that can directly map those permissions in a trusted, cross-domain manner. The techniques of this disclosure provide the requisite mapping in a highly-automated and efficient (accelerated) manner, but without requiring the domain controller or any specified cross-domain trust to be established in the first instance.

### Cross-Domain Trust-Independent Permissions Transformation

With the above as background, the following describes the techniques of this disclosure.

By way of brief background, in a typically use case involving a source domain running in Microsoft® Windows®, permissions are encoded in a given format, such as SDDL (Security Descriptor Definition Language). Security descriptors are data structures of security information for securable Microsoft® Windows® objects, namely, objects that can be identified by a unique name. Security descriptors can be associated with any named objects, including files, folders, shares, registry keys, processes, threads, named pipes, services, job objects and other resources. SDDL defines the string format that various Descriptor functions use to describe a security descriptor as a text string. The language also defines string elements for describing information in the components of a security descriptor. For example, security descriptors contain discretionary access control lists (DACLs) that contain access control entries (ACEs) that grant and deny access to trustees such as users or groups. They also contain a system access control list (SACLs) that control auditing of object access. ACEs may be explicitly applied to an object or inherited from a parent object. The order of ACEs in an ACL is important, with access denied ACEs appearing higher in the order than ACEs that grant access. Security descriptors also contain a designation of an object owner.

The following assumes the reader's familiarity with permissions handling in an operating system (OS) such as Microsoft® Windows,® and in an associated directory service, such as Microsoft Active Directory. By way of background, a directory is a hierarchical structure that stores information about objects on the network. A directory service, such as Active Directory Domain Services (AD DS), provides the methods for storing directory data and making this data available to network users and administrators. For example, AD DS stores information about user accounts, such as names, passwords, phone numbers, and so on, and enables other authorized users on the same network to access this information. Security is integrated with Active Directory through logon authentication and access control to objects in the directory. With a single network logon, administrators manage directory data and organization throughout their network, and authorized network users can access resources anywhere on the network. Permissions in Active Directory are access privileges that are granted to users and groups and that permit them to interact with objects. An administrator assigns permissions to a user or a group so that they can access or manage a folder. Typically, Permissions in Active Directory either are standard permissions, which give the user the ability to read or write, or special permissions, which give the user the ability to modify object permissions or owners.

The technique herein may be applied where the permissions dataset is managed in other operating systems, but the Windows®-based solution will be common. In this context, and with reference now to FIG. 5, there are several electronic documents 500, namely, an Identity List 502, a Domain List 504, and an Identity Map 506. An Identity List 502 is typically defined by an NTAccount, which is a name that represents a user or group account, and a SecurityIdentifier (SID), which is the identifier of the NTAccount. The Domain List 504 includes a DomainName, which is typically a NETBIOS name of the Domain, a DomainDnsName, which is the DNS name of the Domain, and a SecurityIdentifer, which is the SID of the Domain. The Identity Map 506 comprises a SourceSecurityIdentifier, which is the source SID that will mapped, a Source NATAccount, which is the source NTAccount to map, a TargetSecurityIdentifier, which is the target SID to map, and a TargetNATAccount, which is the target NTAccount to map.

As also depicted in FIG. 5, the cross-domain permissions migration also leverages several databases and their associated database tables. In particular, an Identity database 508 includes an Account table 510, and a Domain table 512. Account table 510 has several fields, namely, SecurityIdentifier, which is the SID representing an account, and AccountName, which is the account name portion of the NTAccount. The Domain table 512 has several fields, namely, a SecurityIdentifer, which is the SID representing a domain, the DomainName, which as noted is the NETBIOS name of the domain, and DomainDnsName, which as noted is the DNS name of the Domain. In the approach described below, SecurityIdentifer and either DomainName or DomainDns Name are required. As also depicted, an IdentityMap database 514 comprises a set of tables, namely, as IdentityMap table 516, an SourceIdentity Table 518, and a TargetIdentity table 520. An IdentityMap database 514 may be type-specific, and it may be associated with a particular location, department, or other enterprise construct. An IdentityMap table 516 in that database has a SourceIdentity, which is a source SecurityIdentifier (or NTAccount if unavailable), and a TargetIdentity, which the target SecurityIdentifier (or NTACcount if unavailable). The SourceIdentity table 518 has an Identity, which is the source SecurityIdentifier (or NTAccount if unavailable), and the TargetIdentity table 520 has an Identity, which is the target SecurityIdentifier (or NTAccount if unavailable.

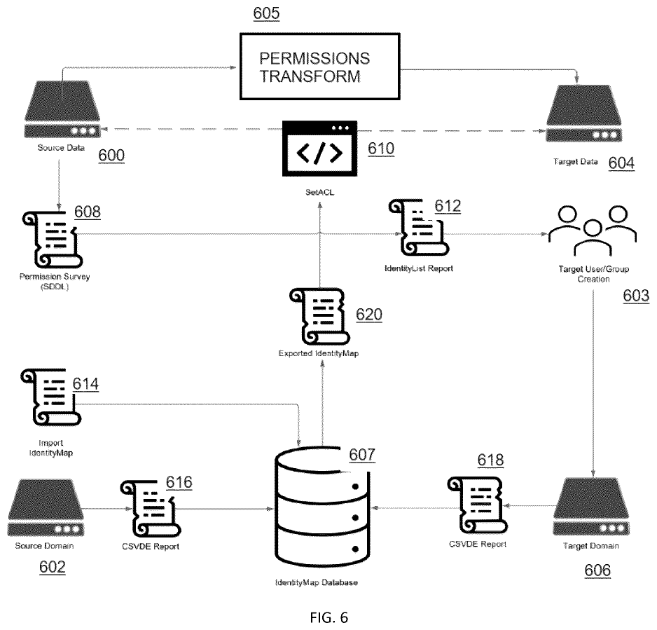

Given the above-definitions and database structures, FIG. 6 depicts an automated workflow for the cross-domain permissions transformation approach of this disclosure. As depicted, there is a set of source data 600 in a source domain 602, and it is desired to transform the source data to a set of target data 604 in a target domain 606. The set of target data 604 is associated with the creation of a set of target users or groups 603. A permissions tool or service 605 is used for this purpose. The permissions tool executes as software, i.e., a set of computer program instructions, executed in one or more processors of a machine. The machine may be a physical computing system, a virtual machine, or some combination thereof. In one embodiment, the source domain 602 is associated with a Microsoft Windows OS with Active Directory as the directory service that stores the source data 600, namely, the set of enterprise permissions that are desired to be migrated. As will be described, the permissions tool 605 implements a domain permissions migration workflow and it operates either on-premises in the enterprise, or otherwise in association with a cloud infrastructure. As will be described, the permissions tool 605 primarily leverages the IdentityMap database 607 having the data tables and data described above with respect to FIG. 5. As also depicted, an SDDL Permission Survey 608 is associated with the source data 600 and includes a SetACL Report 610. The SetACL report 610 comprises all files/folders and their associated permissions that are to be migrated by the permissions tool. An IdentityList Report 612 is a report of all accounts appearing in the Permission Survey 608. As will be described, an Import IdentityMap 614 is imported into the IdentityMap database 607. The nature and format of the Import IdentityMap 614 typically is implementation-specific and depends on enterprise requirements. As further depicted, a CSVDE Report 616 (generated by an AD DS CSVDE tool) exports an account list from the source domain, and a CSVDE Report 618 generated by a similar/same tool exports an account list from the target domain. Finally, FIG. 6 also depicts an Exported IdentityMap 620 that is exported from the IdentityMap database 607 to facilitate the permissions transformation, as will now be described.

In particular, the IdentityMap database 607 stores a database script (or a set of one or more scripts) that carries out the permissions transform without a domain controller or cross-domain trust. The functions of the script may be carried out in native code or in other systems, devices, processes or programs. According to the technique, permissions transformation are applied to either source data or target data, and the preferred approach carries out the transformation using the SIDs of accounts, rather than account names. Because the permissions transformation may occur from the source domain to the target domain, or vice versa, the approach herein may thus be described in the more general sense of a permission transform from an old domain to a new domain. This approach is now described with respect to the typical case involving a transformation from a source to a target.

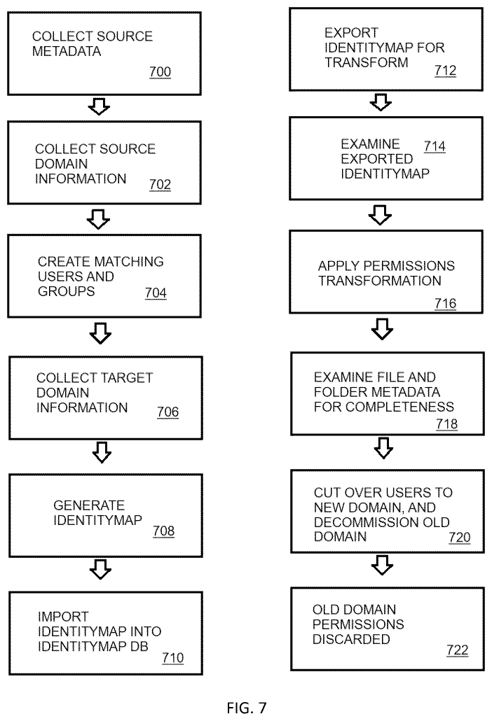

With reference now to the process flow in FIG. 7, at step 700, information on source metadata is collected. Typically, this operation includes several sub-steps. First, a utility (e.g., Microsoft SetACL) is used to obtain a list of file and folder permissions from the source system. This is the SetACL Report depicted in FIG. 7, and this report is encoded in an SDDL format. Second, the SetACL report is converted into an Identity List, listing all the trustees (owners) and SIDs that appear on the source file system. This is the IdentityList Report 612 in FIG. 6. At step 702, information on the source domain is then collected. This operation also includes several sub-steps, namely, using the CSVDE utility for Microsoft Active Directory to get information from the source directory. This is the CSVDE Report 616. The CSVDE Report is split into Identity List and Domain List documents types and then imported in to the Identity database (IdentityMap database 607). Control then continues at step 704 to create matching users and groups (shown in FIG. 6 as 606) in the target data directory. This step may involve a name change to a formulaic name associated with the target domain. At step 706, information from the target domain is collected in the form of the CSVDE Report 616 previously described. At step 708, an IdentityMap electronic document type is generated and then populated using the source SID and/or trustee gathered in step 700, and filling in the Target NTAccount Identity field using the name or formulaic name from step 704. At step 710, the new IdentityMap resulting from step 708 is imported into the IdentityMap database. As will be described below, this import involves validating the new IdentityMap against existing entries in the database. Based on this validation, the existing entries in the database may be overridden, or the new IdentityMap discarded. As a result, a relationship is established in the IdentityMap database between the source and target identities, as well as the NTAccounts/SIDs that represent them. At step 712, the IdentityMap is exported from the IdentityMap database. During this export process, an export script fills in all available blanks (in the map) using the relationships specified in the database.

Control then continues at step 714. At this step, the exported IdentityMap is examined for completeness. If there are any gaps in the map, e.g., caused by account names in the target domain that do not match the format established in step 704, additional electronic documents with the missing information may be imported (to fill those gaps). At step 716, a permissions transform is then applied to the source metadata (or a replica thereof). Step 716 includes several sub-steps. First, the IdentityMap is converted into a CSV format with the key: value pair {SourceSecurityIdentifier, TargetSecurityIdentifer]. Second, the permissions transform is applied, e.g., using the SetACL utility. SetACL is a utility for manipulating security descriptors on Microsoft Windows. It support various object types and has several capabilities, namely, managing permissions on local or remote systems in domains or workgroups, setting multiple permissions for multiple users or groups, controlling how permissions are inherited, listing, backing up and restoring permissions, setting an owner to any user or group, removing, replacing or copying a user or group from an ACL, and filtering out object names where appropriate. Using the SetACL utility, new permissions are supplemented for the new domain matching the permissions from the old domain. Advantageously, the presence of the SecurityIdentifier information eliminates any requirement to resolve any names, e.g., using Active Directory data structures or operations. With the permissions transform complete, control then continues at step 718. At this step, the system examines the file and folder metadata to ensure the transformation is accurate and complete. Because both the source and target permissions are still present on the files, permissions now work for both the source and target user and group accounts, and they are not dependent on each other.

At step 720, users are cut over to the new domain, and the old domain is decommissioned. At step 722, optionally the old domain permissions are then discarded. To this end, a utility is used to remove the broken SIDs that are left behind when the old domain is decommissioned. This completes the process.

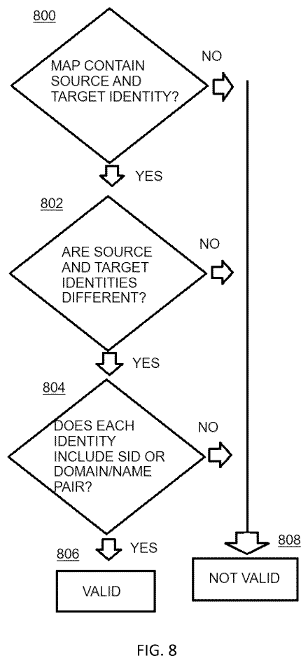

Referring now to FIG. 8, a detailed process flow is shown of the IdentityMap validation operation referenced in step 710 of the main process flow described above. The purpose of this validation is to ensure that a new IdentityMap contains enough information to establish a relationships between source and target identities. To this end, at step 800 the routine tests whether the map contains both a source and target identity. If so, the routine tests at step 802 whether the source and target identity are different. If the outcome of the test at step 802 is positive, the routine continues at step 804 to test whether each of the source and target identities includes at least a complete and valid SecurityIdentifier, or a complete Domain\Account Name pair (e.g., domain.com\GroupName” as compared to just “GroupName”). In this processing an NTAccount name with no domain component (e.g., “GroupName”) is allowable if the NTAccount name is accompanied by a valid SecurityIdentifier. If the result of each of validation steps 800, 802 and 804 is positive, then the system obtains an indication there is an appropriate relationship established between an old and new identity. This is step 806. For processing efficiency, this relationship is established using the minimum amount of information necessary to ensure that the identity is uniquely identifiable, but also without limiting the relationship to be specified to require both a full SecurityIdentifier and Domain\Username pair. If, however, the outcome of any of the validation steps 800, 802 or 804 is negative, the routine branches to 808, and the relevant entries are not validated.

Thus, preferably an IdentityMap comprises at least one identity, although this is not a limitation. A new IdentityMap for an identity preferably is compared to any existing IdentityMap entries in the IdentityMap database. If the new IdentityMap matches an existing IdentityMap, the new IdentityMap is disregarded. Typically, the relationship between the source and target identities with the database are a many-to-one relationship; each source identity must be mapped to only one target identity, but multiple source identities can be mapped to a given target identity. If the above constraint is broken by a new IdentityMap entry, or if the new IdentityMap entire otherwise conflicts with an existing entry, the system may issue a prompt to have a user or administrator resolve the conflict, e.g., by overriding the existing IdentityMap relationship or discarding the new IdentityMap. As a variant, the conflict may be resolved by application of one or more automated conflict resolution rules. As a result of running the above-identified validation, a relationship is established in the database between the source and target identifies, and the NTAccounts/SIDs that represent them.

The IdentityMap database may be updated dynamically, synchronously or asynchronously.

The approach herein provides significant advantages, primarily the ability to provide automated cross-domain permissions transformation without the presence of a domain controller or even trust. According to the technique described above, permissions metadata is collected from a source file and folder structure, and information regarding users, groups and security identifiers is collected for both a source and a target domain. These data sets organized according to a set of configured electronic documents and stored in a relational database. The information in the database is validated on an identity-by-identity basis and exported into a format that allows permissions metadata for the source file and folder structure to be applied either to the original location, or to a replica location. In one embodiment, that replica location is a cloud-native global file system. The approach herein operates in an automated or semi-automated manner, and it greatly accelerates transformation of permissions. There is no requirement to enforce trust across the domains, or to have administrator domain credentials in place on both sides. Using the approach herein, and irrespective of the size or number of accounts, an enterprise can confidently and expeditiously move its enterprise data to the hybrid cloud with all roles and permissions intact.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be specially constructed for the required purposes, or it may comprise a computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A computer-readable medium having instructions stored thereon to perform the interface functions is tangible.

A given implementation of the disclosed subject matter is software written in a given programming language that runs on a server on an hardware platform running an operating system such as Linux. As noted above, the interface may be implemented as well as a virtual machine or appliance, or in any other tangible manner.

While given components of the system have been described separately, one of ordinary skill will appreciate that some of the functions may be combined or shared in given instructions, program sequences, code portions, and the like.

In a Microsoft®
content, a domain is a logical group of network objects such
as computers, users, and devices that share a same Active Directory database.
A Windows™ domain is essentially a network of controlled computers used in a business
setting, with at least one server, called a domain controller, in charge of the other devices.

Having described the subject matter herein, what we claim is as follows:

1. A method of automated, cross-domain permissions transformation, comprising:
collecting permissions metadata from a source system;
converting the permissions metadata into a first identity list, the first identity list including a set of security identifiers (SID) that appear in the source system;
collecting information associated with a source domain, and a target domain;
converting the information into a second identity list, and a domain list;
creating a set of users and groups in the target domain and that are associated with a set of accounts, wherein each account has an account name;
creating an identity map, and populating the identity map with at least one or more SIDs from the first identity list, together with the account name;
based on the identity map, storing an association between a source identity and a target identity, together with the SIDs and account names that represent the source and target identities; and
using the identity map, applying a permissions transform, wherein at least one permission transform is carried out using an SID of an account in lieu of an account name.

2. The method as described in claim 1, wherein the permissions transform is carried out without a domain controller.

3. The method as described in claim 1, wherein the permissions transform is carried out irrespective of whether the source and target domains have an established trust relationship.

4. The method as described in claim 1, wherein the target domain is associated with a cloud-native global file system.

5. The method as described in claim 1, wherein the permissions transform is executed in a SetACL utility.

6. The method as described in claim 1, wherein the permissions transform is carried out from the source domain to the target domain, or from the target domain to the source domain.

7. The method as described in claim 1, further including validating the identity map.

8. The method as described in claim 7, wherein validating the identity map determines whether the identity map has given information to establish a relationship between the source and target identities.

9. The method as described in claim 8, further including supplementing the identity map based on a determination that the identity map does not have the given information.

10. The method as described in claim 7, further including selectively overriding given information in the identity map.

11. The method as described in claim 1, further including determining an accuracy of the permissions transform.

12. The method as described in claim 1, wherein a transformed permission is associated with both a source domain permission for a set of users and groups in the source domain, and a target domain permission for the set of users and groups in the target domain.

13. The method as described in claim 12, further including decommissioning the source domain permission.

14. The method as described in claim 1, wherein the identity map is an intermediary data structure stored in an identity map database.
